(19) United States
(12) Patent Application Publication
(10) Pub. No.: US 2005/0013916 A1
(43) Pub. Date: Jan. 20, 2005

(54) Mixtures of sucrose or high fructose corn syrup (HFCS) 42 or HFCS 55 and high-intensity sweeteners with a taste profile of pure HFCS 55

(76) Inventor: Susanne Rathjen, Darmstadt (DE)

Correspondence Address: ProPat, L.L.C., 2912 Crosby Road, Charlotte, NC, 28211-2815, US

(21) Appl. No.: 10/637,283

(22) Filed: Aug. 8, 2003

Related U.S. Application Data
(63) Continuation-in-part of application No. 10/619,151, filed on Jul. 14, 2003, now abandoned.

(51) Int. Cl. A23L 1/236

(52) U.S. Cl. 426/548

(57) ABSTRACT

The invention relates to a mixture with a sweetness and taste profile of pure HFCS 55 (=standard=100 wt.-%), which mixture comprises only 10-50 wt.-% (based on the standard) of E) one or more compounds selected from the group consisting of: HFCS 55, HFCS 42 and Sucrose and F) 0.002-0.05 wt % (based on the standard) of a mixture of either Acesulfame K and Aspartame or Acesulfame K and Sucralose.

### CLAIM FOR PRIORITY

This application is a continuation-in-part of Ser. No. 10/619,151 filed Jul. 14, 2003.

### BACKGROUND OF THE INVENTION

High fructose corn syrups are isomerized corn syrups derived from the isomerization of glucose in the syrup to fructose by the enzyme isomerase. In certain regions syrups with levels of 42% fructose and 55% fructose are mainly used in beverages instead of sugar for cost reasons. It is well accepted that the taste quality of HFCS 55 is superior to HFCS 42 and that both taste profiles are different with respect to sucrose. HFCS 55 can be regarded as sweetness standard in certain region and product categories.

High intensity sweeteners are synthetic or natural substances, which have no or virtually no calories and a sweetness potency several times higher than sugar. High intensity sweeteners or blends of high intensity sweeteners are used in food and beverages to achieve a sweet taste without adding calories to the products. High intensity sweeteners commonly used are acesulfame K, alitame, aspartame, cyclamate, lo han go, neohesperidine dihydrochalcone, neotame, saccharin, stevioside and sucralose.

The ongoing debate on obesity in developed countries and the growing health consciousness of consumers lead to an increasing demand of beverages with at least 50% calorie reduction compared to products fully sweetened with carbohydrates and a taste profile similar to the sweetness standard HFCS 55.

However, no high-intensity sweetener matches the taste profile of HFCS 55 completely. They differ in characteristics such as sweetness profile, side taste and off-taste characteristics. Proper blending of different high intensity sweeteners is known to overcome part of the taste limitations of single high-intensity sweeteners. But even if a more HFCS 55-like sweetness profile is achieved in products with high-intensity sweeteners only, they still can be distinguished sensorically from their counterparts with just HFCS 55 by lack of mouthfeel and reduced flavour characteristics.

### PRIOR ART

Fry (Sugar replacement in non-diet soft drinks, Food Technology International Europe, 83-86, 1995) describes 30 and 50% calorie reduced sweetening concepts in cola and lemonades using combinations of either glucose syrup and aspartame or low-fructose syrups and aspartame. Using a consumer panel it was shown that the taste profile of none of these sweetening systems was similar to sucrose. In fact the glucose syrup/aspartame and low-fructose syrup aspartame mixtures showed statistically significant differences in sweetness, acidity, sweet aftertaste, bitter aftertaste, length of aftertaste, liking for aftertaste, mouthfeel, odour liking, flavour liking and overall liking.

Simon (Simon et al., Combinations of glucose syrups and intense sweeteners, application in calorie reduced soft drinks. In 'FIE. Food ingredients Europe. Conference proceedings, Paris 27, 28, 29 September 1989′. Maarssen, Netherlands; Expoconsult Publishers, 330-333, 1989) recommends using 3% glucose syrup and different combinations of high-intensity sweeteners, which are calculated from a computer model without giving any sensory description of their taste profiles compared to sugar.

Lotz and Meyer (Lotz, A., Meyer, E.: Sweeteners in beverages—New developments, Food Marketing & Technology, 4-91, 1994.) recommend recipes using sugar and sweetener blends stating that these combinations create a “nicely balanced sweetness” without showing any sensory results compared to sugar.

Thus, no proper blending of different high intensity sweeteners alone or mixtures with sucrose or HFCS are known, which matches the taste profile of HFCS 55 sufficiently.

It was therefore an objective for the present invention to develop a mixture having a taste profile similar to HFCS 55 but containing reduced amounts of HFCS 55.

### BRIEF DESCRIPTION OF THE INVENTION

The present invention, therefore, relates to a mixture with a sweetness and taste profile of pure HFCS 55 (=standard=100 wt.-%), which mixture comprises only 10-50, preferably 15-50, especially preferred 20-40 wt.-% (based on the standard) of
A) one or more compounds selected from the group consisting of: HFCS 55, HFCS 42 and Sucrose and
B) 0.002-0.05, preferably 0.005-0.03, especially preferred 0.007-0.02 and even more preferred 0.009-0.015 wt % (based on the standard) of a mixture of either Acesulfame K and Aspartame or Acesulfame K and Sucralose

### DETAILED DESCRIPTION OF THE INVENTION

Although neither HFCS 42 nor blends of Acesulfame K/Aspartame or Acesulfame K/Sucralose match the taste profile of HFCS 55 as such completely, surprisingly it was observed that certain mixtures of either HFCS 55 or HFCS 42 or Sucrose plus either Acesulfame K/Aspartame or Acesulfame K/Sucralose have a taste profile which is not significantly different from HFCS 55 with significantly reduced calories.

The weight ratio of the two high intensity sweeteners in the mixtures are:
Acesulfame K/Aspartame 20/80 to 70/30 (w/w), preferably 30/70 to 60/40 (w/w)and especially preferred 35/65 to 55/45 (w/w);
Acesulfame K/Sucralose 25/75 to 80/20 (w/w), preferably 30/70 to 70/30 (w/w) and especially preferred 40/60 to 70/30 (w/w).

These mixtures of reduced carbohydrate sweeteners with high intensity sweeteners meet the objective of partial sugar replacement and calorie reduction and can be used in e.g. beverages. Suitable beverages according to the invention are all alcoholic beverages and non-alcoholic soft drinks, carbonated or non-carbonated. Examples of these are cola, orangeades, lemonades, iced tea drinks, aromatized mineral water, energy drinks, sports drinks, fruit juice drinks and fruit juices.

The mixtures may also contain minor amounts, i.e. up to 10 wt.-%, preferably up to 5 wt.-% of commonly used additives such as flavours, bulking agents weighing agents etc.

The mixture is prepared by simply mixing HFCS 55 and/or HFCS 42 and/or Sucrose with Acesulfame K and Aspartame or Acesulfame K and Sucralose.

The invention further provides for process for partially replacing a carbohydrate sweetener (=standard=100 wt.-%), such as sucrose, HFCS 55 or HFCS 42 under retention of the sweetness and taste profile of such carbohydrate sweetener especially HFCS 55, which process comprises reducing the amount of carbohydrate sweetener to 10-50 wt.-%, preferably 15-50, especially preferred 20-40 wt.-% of the standard and adding 0.002-0.05 wt %, preferably 0.005-0.03, especially preferred 0.007-0.02 and even more preferred 0.009-0.015 wt % (based on the standard) of a mixture of either Acesulfame K and Aspartame or Acesulfame K and Sucralose.

The weight ratio of the two high intensity sweeteners are as shown above for the mixtures.

The invention is further illustrated by the following, non limiting, examples.

### EXAMPLES

Methodology

The sensory analysis was carried out in soft drinks. All sweetening systems employed were sensorically adjusted to 10% (weight) sucrose equivalence. A sensory panel of experts, especially trained to evaluate sweet products, from an independent, experienced sensorial-testing institute established the beverage flavour-specific attributes for the quantitative descriptive analysis. Quantitative assessments were undertaken by each of 12 panellists in individual tasting booths using a 0-100 scale. The order of presentation of samples was balanced across the panellists. Each panellist completed 3 replicates of these quantitative rating assessments.

### Example 1

### 10.15 wt.-% (Solids) HFCS 42 vs. 10 wt.-% Sucrose in a Lemon-Lime Carbonated Beverage

The sensory profiles of a 10.15 wt.-% (solids) HFCS 42 sweetened lemon-lime product vs. a product sweetened with 10 wt.-% (solids) sucrose are shown in diagramm 1 below. Statistically significant sensory differences between the two products were observed (alpha=0.01).

[image]

Beverage system: commercially available lemon-lime flavour (Sensient 1013981), 2.5 g/l citric acid monohydrate, 0.15 g/l sodium benzoate, 6.3 g/l CO2

The so called spider diagram shows a multi parameter graph, describing the overall taste and sweetness profile of food products. The different attributes itself like e.g. acidity or sweet AT (after taste) as well as the intensity of these attributes are the result of a multi test person sensory panel trial.

The size area integral itself does not have any meaning. However, the shape of the respective integral characterises the taste profile as such. Thus, the more the area integral of two different types of food products e.g. beverages show a similar shape or form, the better the taste profiles can be described as being not significantly different form each other.

### Example 2

### 10.15 wt.-% (Solids) HFCS 55 vs. 10 wt.-% Sucrose in a Lemon-Lime Carbonated Beverage

The sensory profiles of a 10.15 wt.-% (solids) HFCS 55 sweetened lemon-lime product vs. a product sweetened with 10 wt.-% (solids) sucrose are shown in diagramm 2. Statistically significant sensory differences between the two products were observed (alpha=0.01).

[image]

[image]

Beverage system: commercially available lemon-lime flavour (Sensient 1013981), 2.5 g/l citric acid monohydrate, 0.15 g/l sodium benzoate, 6.3 g/l CO2

### Example 3

### 10.15% (Solids) HFCS 55 vs. 2% HFCS 42+acesulfame K/aspartame in a Lemon-Lime Carbonated Beverage

The sensory profiles of a 10.15 wt.-% (solids) HFCS 55 sweetened lemon-lime product vs. a product sweetened with 2 wt.-% (solids) HFCS 42 plus a acesulfame K/aspartame are shown in diagramm 3. No statistically significant sensory differences between the two products were observed (alpha=0.01).

[image]

[image]

Beverage system: commercially available lemon-lime flavour (Sensient 1013981), 2.5 g/l

citric acid monohydrate, 0.15 g/l sodium benzoate, 6.3 g/l CO2
Sweetening systems: 10.15 wt.-% (solids) HFCS 55; 2 wt.-% (solids) HFCS 42+0.115 g/l acesulfame K+0.115 g/l aspartame

### Example 4

### 10.15 wt.-% (Solids) HFCS 55 vs. 2 wt.-% HFCS 42+acesulfame K/Sucralose in a Lemon-Lime Carbonated Beverage

The sensory profiles of a 10.15 wt.-% (solids) HFCS 55 sweetened lemon-lime product vs. a product sweetened with 2 wt.-% (solids) HFCS 42 plus acesulfame K/Sucralose are shown in diagramm 4. No statistically significant sensory differences between the two products were observed (alpha=0.01).

[image]

Beverage system: commercially available lemon-lime flavour (Sensient 1013981), 2.5 g/l

citric acid monohydrate, 0.15 g/l sodium benzoate, 6.3 g/l CO2
Sweetening systems: 10.15 wt.-% (solids) HFCS 55; 2 wt.-% (solids) HFCS 42 +0.090 g/l acesulfame K+0.097 g/l Sucralose

### Example 5

### 10 wt.-% (Solids) HFCS 55 vs. 2 wt.-% sucrose+acesulfame K/Sucralose in a Lemon-Lime Carbonated Beverage

The sensory profiles of a 10.15 wt.-% (solids) HFCS 55 sweetened lemon-lime product vs. a product sweetened with 2 wt.-% (solids) HFCS 42 plus acesulfame K/Sucralose are shown in diagramm 5. No statistically significant sensory differences between the two products were observed (alpha=0.01).

[image]

Beverage system: commercially available lemon-lime flavour (Sensient 1013981), 2.5 g/l

citric acid monohydrate, 0.15 g/l sodium benzoate, 6.3 g/l CO2
Sweetening systems: 10.15 wt.-% (solids) HFCS 55; 2 wt.-% (solids) Sucrose+0.115 g/l acesulfame K+0.115 g/l aspartame

1. A mixture with a sweetness and taste profile of pure HFCS 55 (=standard=100 wt.-%), which mixture comprises only 10-50 wt.-% (based on the standard) of
C) one or more compounds selected from the group consisting of: HFCS 55, HFCS 42 and Sucrose and
D) 0.002-0.05 wt % (based on the standard) of a mixture of either Acesulfame K and Aspartame or Acesulfame K and Sucralose.

2. Mixture as claimed in claim 1, wherein the mixture comprises only 15-50 wt.-% of one or more compounds selected from the group consisting of: HFCS 55, HFCS 42 and Sucrose.

3. Mixture according to claim 1, wherein the mixture comprises 0.005-0.03 wt.-% of a mixture of either Acesulfame K and Aspartame or Acesulfame K and Sucralose.

4. Mixture according to claim 1, wherein the weight ratio of Acesulfame K to Aspartame is 20/80 to 70/30.

5. Mixture according to claim 1, wherein the weight ratio of Acesulfame K to Aspartame is 30/70 to 60/40 (w/w).

6. Mixture according to claim 1, wherein the ratio of Acesulfame K/Sucralose is 25/75 to 80/20 (w/w).

7. Mixture according to claim 1, wherein the ratio of Acesulfame K/Sucralose is 30/70 to 70/30 (w/w).

8. Process for partially replacing a carbohydrate sweetener (=standard=100 wt.-%) under retention of the sweetness and taste profile of the carbohydrate sweetener, which process comprises reducing the amount of carbohydrate sweetener to 10-50 wt.-% of the standard and adding 0.002-0.05 wt % (based on the standard) of a mixture of either Acesulfame K and Aspartame or Acesulfame K and Sucralose.

9. Process as claimed in claim 8, wherein the amount of carbohydrate sweetener is reduced to 15-50 wt.-%.

10. Process according to claim 8, wherein 0.005-0.03 wt.-% of a mixture of either Acesulfame K and Aspartame or Acesulfame K and Sucralose is added.

11. Process according to claim 8, wherein the weight ratio of Acesulfame K to Aspartame is 20/80 to 70/30.

12. Process according to claim 8, wherein the weight ratio of Acesulfame K to Aspartame is 30/70 to 60/40 (w/w).

13. Process according to claim 8, wherein the ratio of Acesulfame K/Sucralose is 25/75 to 80/20 (w/w).

14. Process according to claim 8, wherein the ratio of Acesulfame K/Sucralose is 30/70 to 70/30 (w/w).

15. Beverage comprising a mixture according to claim 1.
